(19) United States
(12) Patent Application Publication
(10) Pub. No.: US 2025/0213988 A1
(43) Pub. Date: Jul. 3, 2025

(54) GAME SYSTEM, NON-TRANSITORY COMPUTER-READABLE RECORDING MEDIUM, AND CONTROL METHOD

(71) Applicants: Square Enix Co. Ltd., Tokyo (JP); Precious Analytics Inc., Tokyo (JP)

(72) Inventors: Naoyuki TAMATE, Tokyo (JP); Yosuke TOYODA, Tokyo (JP); Hiroki YONEMOTO, Tokyo (JP)

(21) Appl. No.: 19/004,050

(22) Filed: Dec. 27, 2024

(30) Foreign Application Priority Data
Dec. 27, 2023 (JP) 2023-220492

(51) Int. Cl. A63F 13/79

(52) U.S. Cl. CPC A63F 13/79

(57) ABSTRACT

The present disclosure provides a new game system capable of promoting distribution of a non-fungible token (NFT) content. An example game system comprises: a terminal device for executing a video game including one or more contents used in the video game; a server device connected to the terminal device via a communication network; and at least one processor that: progresses the game; associates a first user as an owner of the first content; generates second content related to the first content based on at least a part of information of the first content; provides the second content to the second user; and issues a non-alternative token related to a second content by a predetermined period after the second content is given to the second user.

### CROSS REFERENCE TO RELATED APPLICATION(S)

The present disclosure claims priority to Japanese Patent Application No. 2023-220492, filed on Dec. 27, 2023, the disclosure of which is expressly incorporated herein by reference in its entirety for any purpose.

### BACKGROUND

The present disclosure relates to a video game processing program, a server device, a game system, a control method, and a terminal device.

In recent years, games using distributed ledger technology (Distributed Ledger Technology (DLT)) or blockchain technology have begun to be offered (see, e.g., “CRYPTO SPELLS”, [online], CryptoGames, [search on Nov. 29, 2022], Internet <URL: https://cryptospells.jp/>). In the game, for example, the user holds in-game contents such as characters and items used in the game as a non-substitution token (Non Fungible Token (NFT), Non-Fungible Token).

The NFT can perform trading transactions in a predetermined market such as a marketplace, and the transaction history is described in a ledger included in the blockchain network.

### SUMMARY

In the above-described game using the NFT, advantages to the user who possesses the NFT content are insufficient, and the distribution of the NFT content cannot be promoted.

An object of at least one embodiment of the present disclosure is to provide a new game system capable of promoting distribution of NFT content.

According to a non-limiting aspect, a video game processing program according to the present disclosure is a video game processing program for causing a server device in a game system including a terminal device for executing a video game including one or more contents used in a video game and a server device connected to the terminal device via a communication network to control the video game, the program causing the server device to progress the game, a video game processing program for realizing: a first content associating unit that associates a first user as an owner of a first content; a second content generating unit that generates second content related to the first content based on at least a part of information of the first content; a granting unit that grants the second content to the second user; and an issuing unit that issues a second non-alternative token related to the second content until a predetermined period after granting the second content to the second user.

According to a non-limiting aspect, a server apparatus according to the present disclosure is a server apparatus in a game system including: a terminal apparatus that executes a video game including one or more contents used in the video game; and a server apparatus that is connected to the terminal apparatus via a communication network, wherein the server apparatus includes game progressing means that progresses the game, and first content associating means that associates a first user as an owner of the first content, according to another aspect of the present disclosure, there is provided a server apparatus including: a second content generation unit configured to generate second content related to the first content based on at least a part of information included in the first content; an assignment unit configured to assign the second content to the second user; and an issuance unit configured to issue a second non-alternative token related to the second content until a predetermined period after the second content is assigned to the second user.

According to a non-limiting aspect of the present disclosure, there is provided a game system including: a terminal device that executes a video game including one or more contents used in the video game; and a server device that is connected to the terminal device via a communication network, wherein the game system includes: game progressing means that progresses the game; first content associating means that associates a first user as an owner of the first content; and at least a part of information included in the first content, according to another aspect of the present disclosure, there is provided a game system including: a second content generation unit configured to generate a second content related to a first content; a granting unit configured to grant the second content to a second user; and an issuing unit configured to issue a second non-alternative token related to the second content until a predetermined period after the second content is granted to the second user. According to a non-limiting aspect, a control method according to the present disclosure is a control method executed in a game system including: a terminal device that executes a video game including one or more contents used in the video game; and a server device that is connected to the terminal device via a communication network, wherein the control method includes the steps of: advancing the game; associating a first user as an owner of a first content with the first user; and associating the first user with the first user as an owner of the first content based on at least a part of information included in the first content, the second non-alternative token related to the second content is issued by a predetermined period after the second content is given to the second user.

According to a non-limiting aspect, a terminal device according to the present disclosure is a terminal device in a game system comprising: a terminal device that executes a video game including one or more contents used in the video game; and a server device that is connected to the terminal device via a communication network, wherein the terminal device comprises: game progressing means that progresses the game; first content associating means that associates a first user as an owner of the first content; and at least a part of information included in the first content, a terminal device comprising: a second content generation unit configured to generate a second content related to a first content; a granting unit configured to grant the second content to a second user; and an issuing unit configured to issue a second non-alternative token related to the second content until a predetermined period after the second content is granted to the second user.

One or more deficiencies are solved by embodiments of the present disclosure.

### BRIEF DESCRIPTION OF THE DRAWINGS

FIG. 1 is a block diagram showing a configuration of a game system corresponding to at least one embodiment of the present disclosure.

FIG. 2 is a block diagram showing a configuration of a game system corresponding to at least one of the embodiments of the present disclosure.

FIG. 3 is a flowchart of an execution process corresponding to at least one of the embodiments of the present disclosure.

FIG. 4 is a block diagram showing a configuration of a game system corresponding to at least one of the embodiments of the present disclosure.

FIG. 5 is a flowchart of an execution process corresponding to at least one of the embodiments of the present disclosure.

FIGS. 6A-6D each are a diagram for explaining generation of related content whose appearance is changed, corresponding to at least one of the embodiments of the present disclosure.

FIGS. 7A-7C each are a diagram illustrating generation of related content in which parameters of the first content are changed, corresponding to at least one of the embodiments of the present disclosure.

FIGS. 8A-8D each are a diagram illustrating generation of related content in which the skill of the first content is changed, corresponding to at least one of the embodiments of the present disclosure.

### DETAILED DESCRIPTION

Hereinafter, embodiments of the present disclosure will be described with reference to the accompanying drawings. Hereinafter, the description of the effects is one aspect of the effects of the embodiment of the present disclosure and is not limited to those described here. Further, the description of the content described as an example of a certain embodiment may be omitted in other embodiments. Furthermore, descriptions of operations and processes that are not related to the characteristic portions of the embodiments may be omitted. The order of the respective processes included in the flowchart described below is unequal as long as no contradiction or mismatch occurs in the contents of the processes.

### First Embodiment

An outline of a first embodiment of the present disclosure will be described. Hereinafter, as a first embodiment, a game system including a terminal device that executes a video game including one or more contents and a server device that is connected to the terminal device via a communication network will be described as an example.

### Game Summary

In the first embodiment of the present disclosure, the content is, as one example, digital content usable in a game, and more specifically, refers to an NFT art, a character, an enemy object, an object that can be placed in an in-game space, an item that can be used by a character, and the like.

As an example of the game according to the first embodiment, for example, a game having a feature of “Hold to Earn (H2E)” capable of favoring the progress of the game by possessing an NFT art is exemplified. However, the present disclosure is not limited to this game, and is within the scope applicable to those skilled in the art by the present disclosure.

### Game System

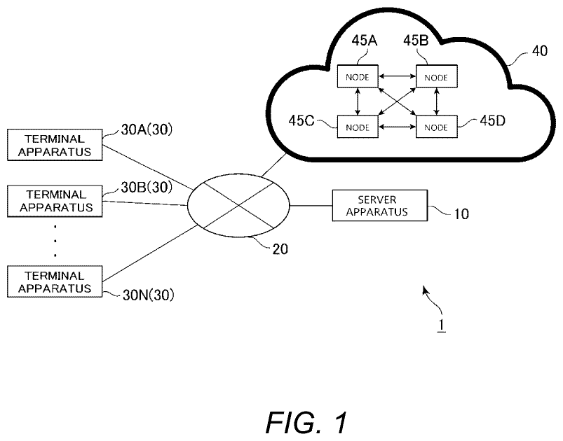

FIG. 1 is a block diagram showing a configuration of a game system corresponding to at least one embodiment of the present disclosure. As illustrated in FIG. 1, a game system (system) 1 includes a server device 10, a communication network 20, client terminal devices 30 (30A, 30B, . . . , 30N: Nis a natural number) used by a plurality of users (players) who play a video game (game), and a distributed ledger network (also referred to as a block chain network) 40 connected to share contents of a distributed ledger.

The configuration of the game system 1 is not limited thereto, and for example, the server device 10 may be configured by a plurality of server devices, or may be configured by a virtual server device using a cloud computing technology. The server device 10 and the terminal device 30 are communicably connected to each other. The terminal device 30 and the server device 10 may not be always connected to each other, and may be connected to each other as necessary.

### Server Device

As an example, the server device 10 includes at least a control unit, a RAM, a storage unit, and a communication interface, which are connected to each other by an internal bus. The controller may comprise an internal timer. The communication interface may also be used to synchronize with an external server. As a result, the actual time can be acquired.

The server device 10 may be a game processing server that controls the progress of the game. In this case, the server device 10 controls the progress of the game in accordance with the operation of the player. The server device 10 may provide the user with various electronic services other than the game.

### Communication Network

The communication network 20 may be, for example, the Internet or a LAN, as long as communication is possible between connected devices.

### Terminal Device

The terminal device 30 includes, for example, a control unit, a RAM, a storage unit, a sound processing unit, a graphics processing unit, a communication interface, and an interface unit, which are connected to each other by an internal bus. The graphics processing unit is connected to the display unit. The display unit may include a display screen and a touch input unit that receives an input by a user's contact with the display unit.

The touch input unit may be, for example, a touch input unit that can detect a contact position using any method such as a resistive film method, a capacitive method, an ultrasonic surface acoustic wave method, an optical method, or an electromagnetic induction method used in a touch panel, and the method is not particularly limited as long as the touch input unit can recognize an operation by a touch operation of a user. This is a device capable of detecting the position of a finger or the like when an operation such as pressing or moving the upper surface of the touch input unit with a finger, a stylus, or the like is performed.

An external memory (for example, an SD card or the like) may be connected to the interface unit. Data read from the external memory is loaded into the RAM, and arithmetic processing is executed by the control unit.

The communication interface can be connected to a communication network wirelessly or by wire, and can receive data via the communication network. The data received via the communication interface is loaded into the RAM in the same manner as the data read from the external memory, and arithmetic processing is performed by the control unit.

The terminal device 30 may include a sensor such as a proximity sensor, an infrared sensor, a gyro sensor, or an acceleration sensor. The terminal device 30 may include an imaging unit that includes a lens and captures an image via the lens. Further, the terminal device 30 may be a wearable terminal device.

### Distributed Ledger Network

The distributed ledger network 40 may include a plurality of nodes 45, such as computing devices, that store the distributed ledger in a storage device. In the figure, nodes 45A to 45D are shown as examples, but the number of nodes is not limited to four.

In the distributed ledger network 40, data of a unit called a block is generated, and a block chain is formed by connecting the data as a chain. By storing the same distributed ledger in each node, the information can be kept secure. The server device 10 and/or the terminal device 30 may be communicably connected to the distributed ledger network 40. The server device 10 and/or the terminal device 30 may function as nodes included in the distributed ledger network 40.

### Content

As described above, the content is digital content, and is an object, an item, or the like that can be used in a game. For example, the user can purchase (primary distribution) digital content in a market capable of trading and selling marketplaces or the like using legal currency, virtual currency, or the like. The user can sell the held content so as to be sold in a marketplace or the like, and can transfer the content to other users (secondary distribution).

### Functional Description

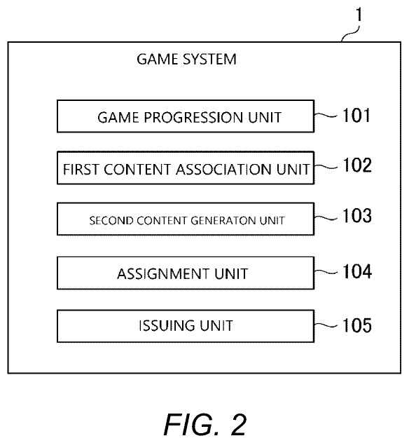

Functions of the game system 1 according to the first embodiment will be described. FIG. 2 is a block diagram showing a configuration of a game system corresponding to at least one of the embodiments of the present disclosure.

The game system 1 may include a game progression unit 101, a first content association unit 102, a second content generation unit 103, an assignment unit 104, and an issuance unit 105.

The game progression unit 101 has a function of progressing the game. The first content associating unit 102 has a function of associating the first user as an owner of the first content. The second content generation unit 103 has a function of generating second content related to the first content based on at least a part of the information of the first content.

The granting unit 104 has a function of granting the second content to the second user. The issuing unit 105 has a function of issuing a second non-substitution token related to the second content until a predetermined period after the second content is given to the second user.

### Execution Process

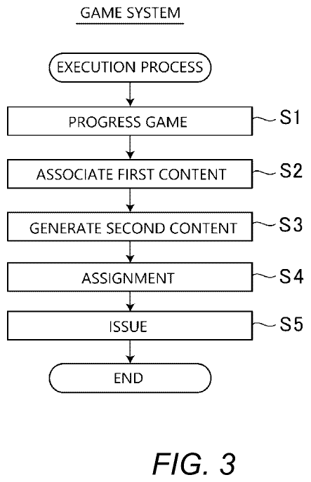

Next, the execution process according to the first embodiment of the present disclosure will be described. FIG. 3 is a flowchart of an execution process corresponding to at least one of the embodiments of the present disclosure.

The game system 1 progresses the game (step S1). The game may progress by receiving input of information from the user. Examples of the input of information include a text input, a handwritten character input, a voice input, and a gesture input.

Next, the game system 1 associates the first user as the owner of the first content (step S2). The first content may be, for example, content given to the first user as the game progresses.

Next, the game system 1 generates second content related to the first content based on at least a part of the information of the first content (step S3). That is, the second content is a content related to the first content.

Next, the game system 1 gives the second content generated in step S3 to the second user (step S4). Next, the game system 1 issues a second non-substitution token related to the second content by a predetermined period after the second content is given to the second user (step S5), and ends the processing.

In the first embodiment, the first content may be a non-alternative token or may not be a token.

As an aspect of the first embodiment, it is possible to provide a new game system capable of promoting distribution of NFT content by generating second content based on at least a part of information of the first content and issuing a non-alternative token (NFT) related to the second content.

In the first embodiment, the “terminal device” refers to, for example, a stationary game machine, a portable game machine, a wearable terminal, a desktop or notebook personal computer, a tablet computer, or a PDA, and may be a portable terminal such as a smartphone having a touch panel sensor on a display screen. The “content” is, for example, digital content that can be used in a game, and more specifically, refers to an NFT art, a character, an enemy object, an object that can be placed in an in-game space, an item that can be used by a character, or the like.

The term “at least a part of the information possessed by the first content” refers to, for example, a part of the information contained in the image information possessed by the first content, the parameter information, the effects available in the game, and the like. “Generation of content” refers to, for example, the game system 1 reading the first content and outputting a new second content different from the first content.

The term “providing” refers to, for example, making a state owned by the user regardless of chargeable or free. The “predetermined period after the assignment” refers to, for example, a period from the time when the content is assigned to the user to the time when the NFT is issued, and more specifically, refers to a period until it is possible to confirm that the trade transaction of the content is completed.

### Second Embodiment

An outline of a second embodiment of the present disclosure will be described. Hereinafter, as a second embodiment, a game system including a terminal device that executes a video game including one or more contents and a server device that is connected to the terminal device via a communication network will be described as an example.

In the second embodiment of the present disclosure, the content is, as one example, digital content usable in a game, and more specifically, refers to an NFT art, a character, an enemy object, an object that can be placed in an in-game space, an item that can be used by a character, and the like. It is preferable that an NFT is issued to the first content and the second content described later.

As an example of the game according to the second embodiment, for example, a game having a feature of “Hold to Earn (H2E)” capable of favoring the progress of the game by possessing an NFT art is exemplified. However, the present disclosure is not limited to this game, and is within the scope applicable to those skilled in the art by the present disclosure.

As an example of the game according to the second embodiment, a state in which the user can trade the NFT may be determined in advance. For example, when starting a game, it may be necessary for the user to have an account in the distributed ledger network.

Regarding the configuration of the game system, the server device 10, the communication network 20, the terminal device 30, the distributed ledger network 40, and the contents in the second embodiment, the contents of the game system, the server device 10, the communication network 20, the terminal device 30, the distributed ledger network 40, and the contents described in the first embodiment can be adopted within a necessary range.

### Functional Description

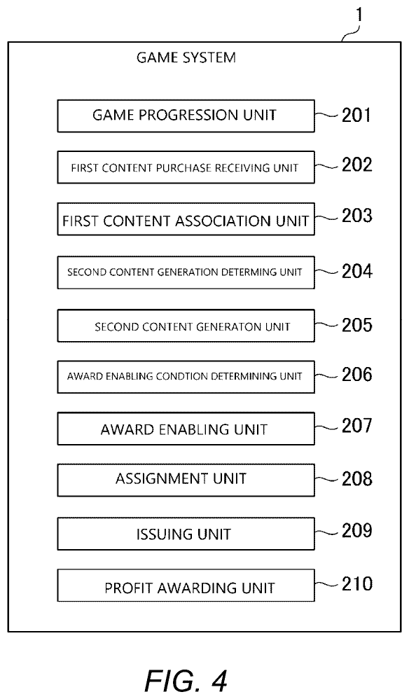

Functions of the game system 1 according to the second embodiment will be described. FIG. 4 is a block diagram showing a configuration of a game system corresponding to at least one of the embodiments of the present disclosure.

The game system 1 may include a game proceeding unit 201, a first content purchase receiving unit 202, a first content associating unit 203, a second content generation determining unit 204, a second content generating unit 205, an award enabling condition determining unit 206, an award enabling unit 207, an awarding unit 208, an issuing unit 209, and a profit awarding unit 210.

The game progression unit 201 has a function of progressing the game. The first content purchase receiving unit 202 has a function of receiving a purchase request of the first content from the first user. The first content associating unit 203 has a function of acquiring the first content based on the purchase request received by the first content purchase receiving unit 202 and associating the first user with the first content.

The second content generation determination unit 204 has a function of determining whether or not to generate the second content. The second content generation unit 205 has a function of generating second content related to the first content based on at least a part of the information of the first content.

The assignable condition determination unit 206 has a function of determining whether or not the second content can be assigned. The assignment enabling unit 207 has a function of enabling the second content to be assigned to a second user different from the first user when a predetermined assignment enabling condition is satisfied.

The granting unit 208 has a function of granting the second content that can be granted by the granting enabling unit 207 to the second user. The issuing unit 209 has a function of issuing a second non-substitution token related to the second content until a predetermined period after the second content is given to the second user. The benefit granting unit 210 has a function of granting a benefit for advantageously proceeding with the game to the user who possesses the content to which the non-alternative token is issued.

### Execution Process

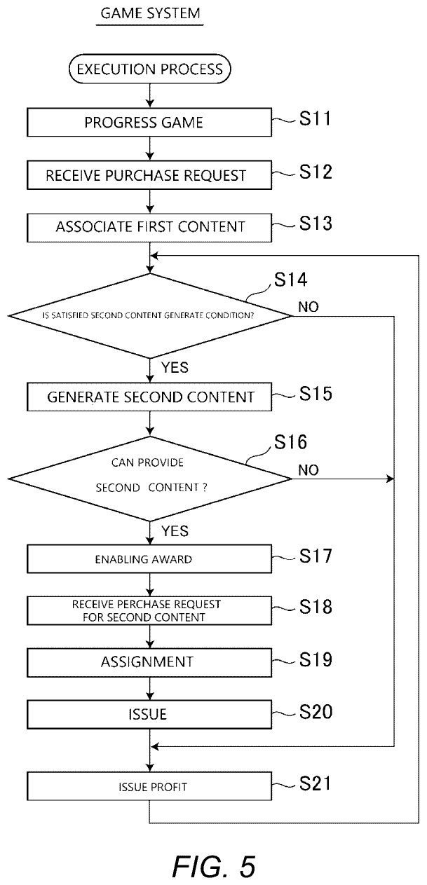

Next, the execution process in the second embodiment of the present disclosure will be described. FIG. 5 is a flowchart of an execution process corresponding to at least one of the embodiments of the present disclosure.

The game system 1 progresses the game (step S11). For convenience of description, the game progress processing is described in the drawings, but the game progress processing may be appropriately executed in the flowchart. That is, the game progress process is not limited to step S11.

Next, the game system 1 receives a purchase request for the first content from the first user (step S12). The first content may be, for example, an NFT issued, and more specifically, may be an NFT art.

Next, the game system 1 associates the first content with the first user based on the purchase request received in step S12 (step S13). When the NFT is issued to the first content, information indicating that the owner is the first user is stored in the node included in the distributed ledger network 40.

Next, the game system 1 determines whether or not the generation condition of the second content is satisfied (step S14). Examples of the second content generation condition include whether or not a predetermined period has elapsed since the first user possesses the first content, whether or not the first user has advanced to a predetermined scene of the game, and whether or not the level of a team (also referred to as a guild or a party) in the game to which the first user belongs exceeds a predetermined reference.

When it is determined in step S14 that the second content generation condition is satisfied (YES in step S14), game system 1 generates second content related to the first content based on at least a part of the information of the first content (step S15). When it is determined in step S14 that the second content generation condition is not satisfied (NO in step S14), the second content is not generated, and the process proceeds to step S21 described below.

Examples of the generation of the content related to the first content include the generation of the content related to an appearance, the generation of the content related to a parameter of the first content, and the generation of the content related to an effect usable in the game of the first content. Details will be described below.

### Generation of Related Content (Change in Appearance)

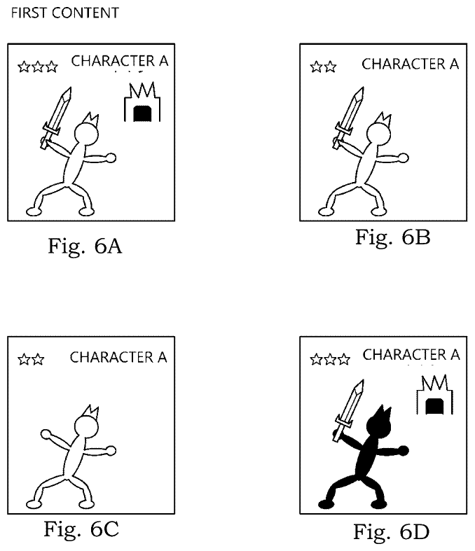

FIG. 6A-6D each are a diagram for explaining generation of related content whose appearance is changed, corresponding to at least one of the embodiments of the present disclosure. FIG. 6A is a diagram illustrating an appearance of the first content.

FIG. 6B is a diagram illustrating an example of the second content. The number of stars described on the upper left decreases, and the background building disappears. That is, it is visually changed based on the appearance of the first content.

FIG. 6C is a diagram illustrating an example of the second content. The number of stars described in the upper left decreases, the background building disappears, and the sword as the weapon also disappears. That is, it is visually changed based on the appearance of the first content.

FIG. 6D is a diagram illustrating an example of the second content. Compared with the first content, the color of the character is painted. That is, it is visually changed based on the appearance of the first content.

As described above, examples of the change in the appearance include a visible change in which some images are added or deleted, the number of colors used is large or small, transparency is different, brightness is different, dots are fine or coarse, and the like.

Alternatively, a part of the images included in the first content may be cut out into the second content. For example, only the image of the sword in FIG. 6A may be extracted to generate the second content.

### Generation of Related Contents (Change of Parameters)

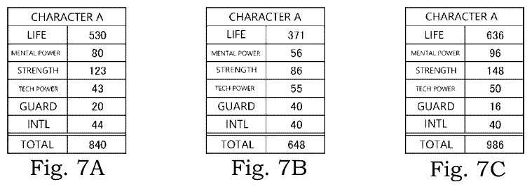

In the game, it is assumed that the content has attribute information. The second content may be generated based on the attribute information of the first content. FIG. 7A-7C each are a diagram illustrating generation of related content in which parameters of the first content are changed, corresponding to at least one of the embodiments of the present disclosure.

FIG. 7A is a diagram illustrating parameters of the first content. As shown in the figure, a plurality of items such as vitality and mentality may be set in the content. In the item, a feature amount indicating a feature in the game of the content is set, and the feature amount may be represented by a numerical value.

FIG. 7B is a diagram illustrating an example of parameters of the second content. The total value of the feature amounts of the items of the first content is set to be larger than the total value of the feature amounts of the items of the second content.

Here, as an example, the total value of the attribute information of the second content may be smaller than the total value of the first content, and the values set for the respective items are not limited to be smaller than those of the first content. For example, the “protective power” of the second content shown in FIG. 7B may be set to a value larger than the “protective power” of the first content shown in FIG. 7A.

FIG. 7C is a diagram illustrating an example of parameters of the second content. The total value of the feature amounts of the items of the first content is set to be smaller than the total value of the feature amounts of the items of the second content.

The parameters set in the second content may be randomly determined by the game system 1 or may be manually determined by the first user.

### [Generation of Related Contents (Change in Skill)]

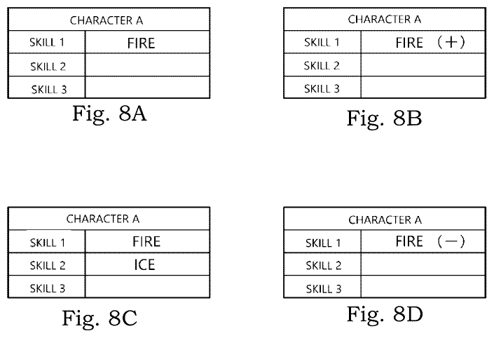

In the game, it is assumed that the content has attribute information. The second content may be generated based on the attribute information of the first content. FIG. 8A-8D each are a diagram illustrating generation of related content in which the skill of the first content is changed, corresponding to at least one of the embodiments of the present disclosure. The skill is a technique that can be used by a character in a game and causes the character to exhibit an effect corresponding to the skill in the game.

FIG. 8A is a diagram illustrating an example of the skill of the first content. For example, three skills can be set in the content.

FIG. 8B is a diagram illustrating an example of the skill of the second content. A skill “fire (+)” having a higher effect than the first content may be set. It is assumed that the strength of the effect is set in advance in the game.

FIG. 8C is a diagram illustrating an example of the skill of the second content. The second content may have the “fire” of the first content, and a new skill may be added to the skill 2.

FIG. 8D is a diagram illustrating an example of the skill of the second content. A skill “fire (−)” having a lower effect than the first content may be set. It is assumed that the strength of the effect is set in advance in the game.

### Generation of Related Content (Conceptual Change)

In the game, it is assumed that the content has attribute information. The second content may be generated based on the attribute information of the first content. The attribute information may include information indicating a parent-child relationship. Although not shown, for example, “father” may be set in the attribute information of the first content, and information indicating the relationship with the first content, such as “long male” and “next female”, may be set in the attribute information of the second content.

The above-described generation of the second content is executed in the game system 1, and may be executed in the server device 10, for example. The generation of the second content may be performed by adopting any of the examples described as the generation of the related content or by combining a plurality of examples.

In the generation of the second content described above, the upper limit number of contents that can be generated may be determined. Further, there may be an increase condition for increasing the upper limit number. For example, it may be designed such that only five second contents can be initially generated, and seven second contents can be generated, for example, by satisfying conditions such as an increase in the level of the player, reaching a predetermined stage, clearing a predetermined mission, and holding the first contents for a predetermined time.

Return to the flowchart of FIG. 5. Next, the game system 1 determines whether or not the second content can be provided (step S16). When game system 1 determines that the second content can be given (YES in step S16), the second content can be given to a second user different from the first user (step S17). When game system 1 determines that the second content cannot be given (NO in step S16), the process proceeds to step S21 described later.

### Application Enabling

The provision enabling of the second content means, for example, enabling the second content to be provided to a second user different from the first user, and more specifically, enabling the second user to acquire the second content. As will be described later, the generated second content is preferably an NFT. In this case, when the information can be acquired, the information can be provided by displaying the information so as to be sold in a predetermined market connected to the distributed ledger network 40.

Next, the game system 1 receives a purchase request for the second content from the second user (step S18). Next, the game system 1 gives the second content to the second user based on the purchase request received in step S18 (step S19).

Next, the game system 1 issues a second non-substitution token related to the second content until a predetermined period after the second content is given to the second user (step S20). Although it is preferable that the time lag from the assignment of the second content in step S19 to the issuance of the NFT corresponding to the second content in step S20 be as short as possible, it may take time to store the NFT in the distributed ledger network 40. Therefore, it is assumed that the completion of the NFT issuance takes a predetermined period of time.

Next, the game system 1 gives a benefit for advantageously proceeding with the game to the user who possesses the content to which the non-substitution token has been issued (step S21).

### Providing a Benefit

Examples of the benefit for advantageously proceeding with the game include increasing the value of attribute information included in the content, adding skills, accumulating experience values of the content in accordance with the held period (the content can be leveled up when the experience values are accumulated up to a predetermined value), deducting the purchase amount of an item or the like available in the game, and making a privilege given when logging in to the game luxury. That is, it is only necessary to provide a merit to the user by holding the NFT content.

The profit may be given depending on the type of the NFT content. For example, even when the first content and the second content have completely the same appearance or parameter, the first content may be held to provide a profit. In this case, no profit is given even if the second content is held. Alternatively, for example, the benefit may not be given even if the first content is held, and the benefit may be given only if the second content is held.

The benefit awarded may be, for example, adding a new story to the story of the game. For example, a new story may be provided to the user who possesses the first content, and a new story may not be provided to the user who possesses the second content. The user who possesses the first content may not be provided with a new story, and the user who possesses the second content may be provided with a new story. Alternatively, for example, a new story may be provided to both the user who possesses the first content and the user who possesses the second content. In this case, it is preferable to provide different stories.

The user may repeatedly execute the processing of steps S14 to S21 while advancing the game, or may suspend or end the game at a timing desired by the user.

In the second embodiment, the upper limit number of distributions may be set for the content of the same content in the game system 1. Since the upper limit number of distributions is determined, it becomes difficult for all users to hold the first content and the second content. On the other hand, the operator may be set so as to be able to add only the first content, and the second content is generated by the game system 1, so that the burden of preparing the content by the operator can be reduced.

In the second embodiment, data may be held so that it can be seen that the first content and the second content related to the first content are related to each other. For example, an identification code for identifying the first content may be designed to be stored as information of the second content. In this way, it is possible to manage the second content derived from the first content. The information indicating the relationship between the first content and the second content may be stored in the server device 10 or may be stored in the distributed ledger network 40.

As an aspect of the second embodiment, it is possible to provide a new game system capable of promoting distribution of NFT content by generating second content based on at least a part of information of the first content and issuing a non-alternative token (NFT) related to the second content.

In the second embodiment, the contents described in the first embodiment can be adopted as “terminal device”, “contents”, “at least a part of the information possessed by the first content”, “generation of content”, “applying”, and “predetermined period after providing” within a necessary range.

In the second embodiment, the “first content” refers to, for example, content from which related content is generated, and may be, for example, content that can be purchased by primary distribution from game operations. The “second content” refers to, for example, a content generated in the game system as a content related to the first content, and as an example, may be a content which is developed in a market by another user, or may be a content which can be purchased in secondary distribution. “Applicable” refers to, for example, being capable of being given to a second user different from the first user, and more specifically, being capable of being acquired by the second user. The “feature quantity” refers to, for example, information representing the properties and characteristics of content in a game, and may be information that can be digitized. The “upper limit number of contents that can be provided” refers to, for example, the number of contents that can be present in the game.

In the present disclosure, the game system 1 includes all the functions, but is not limited thereto. For example, the functions may be distributed to the server device 10, the terminal device 30, and the distributed ledger network 40.

In the present disclosure, the distributed ledger network 40 is described as one type of network. For example, the distributed ledger network 40 that issues the first content and the distributed ledger network 40 that issues the second content may be separated. For example, a network suitable for an operation in which a distributed ledger network in which an auction related to the NFT content is active is used for the first content and a distributed ledger network in which a response of an NFT issue is fast is used for the second content in consideration of a response of a game may be selectively used.

The contents described in each of the above embodiments can be appropriately designed by a person skilled in the art by changing the contents.

### APPENDIXES

In the above description of the embodiments, the following disclosure is described so that those skilled in the art can practice the disclosure.
[1] A game system comprising: a terminal device that executes a video game including one or more contents used in the video game; and a server device that is connected to the terminal device via a communication network, a gaming system includes,
a game progressing means for progressing the game; and,
a first content associating unit that associates a first user as an owner of the first content;
and,
a second content generation means for generating second content related to the first content based on at least a part of information of the first content, providing means for providing the second content to the second user,
an issuing means for issuing a second non-alternative token related to the second content by a predetermined period after the second content is given to the second user.
a game system comprising:
[2] The gaming system further includes,
assignment enabling means for enabling second content to be assigned to second user different from first user when predetermined assignment enabling condition is satisfied the game system according to [1], including:
[3] The second content generation means generates second content related to the first content by visually changing the appearance of the first content, [1] The game system according to [1] or [2].
[4] The content has attribute information,
the second content generation means generates second content related to the first content based on attribute information of the first content, [1] The game system according to [1] or [2].
[5] The attribute information includes a numerically convertible feature quantity set in a plurality of items, the second content generation means further includes,
second content attribute determining means for determining attribute information of second content so as to be less than the total value of feature amounts included in attribute of first content comprising,
the second content generating means generates second content in which the determined attribute information is set, the game system according to [4].
[6] The gaming system further includes,
related attribute information storage means for storing attribute information that can be set to the second content in association with attribute information of the first content comprising,
the second content generating means generates the second content in which the settable attribute information is set, the game system according to [4].
[7] A first non-substitution token related to the first content is issued before the first content is associated with the first user by the first content association unit, the game system according to [1] or [2].
[8] The game system is further connected to a distributed ledger network,
the game system according to [2], wherein the grant enabling unit registers the second content in a predetermined market so that the second content can be sold to the second user.
[9] The game progressing means includes a benefit giving means for giving a benefit for advantageously progressing the game to the user who possesses the content to which the non-alternative token is issued,
The game system according to [1] or [2].
[10] An upper limit number that can be given to the first content and/or the second content is set,

The game system according to [1] or [2].
[11] A video game processing program for causing a server device in a game system including a terminal device that executes a video game including one or more contents used in a video game and a server device that is connected to the terminal device via a communication network to control the video game, in the server device,
a game progressing means for progressing the game; and,
a first content associating unit that associates a first user as an owner of the first content;
and,
a second content generation means for generating second content related to the first content based on at least a part of information of the first content,
Providing means for providing the second content to the second user, an issuing means for issuing a second non-alternative token related to the second content by a predetermined period after the second content is given to the second user.
a non-transitory computer-readable storage medium storing a video game processing program for realizing the above-described configuration.
[12] A server device in which the video game processing program of is installed.
[13] A video game processing program for causing a terminal device to control a video game in a game system including a terminal device that executes the video game including one or more contents used in the video game, and a server device that is connected to the terminal device via a communication network, for a terminal device,
a game progressing means for progressing the game; and,
a first content associating unit that associates a first user as an owner of the first content;
and,
a second content generation means for generating second content related to the first content based on at least a part of information of the first content, providing means for providing the second content to the second user,
an issuing means for issuing a second non-alternative token related to the second content by a predetermined period after the second content is given to the second user.

a non-transitory computer-readable storage medium storing a video game processing program for realizing the above-described configuration.
[14] A terminal device in which the video game processing program of is installed.
[15] A control method executed in a game system comprising: a terminal device that executes a video game including one or more contents used in the video game; and a server device that is connected to the terminal device via a communication network, proceeding with the game, associating the first user as an owner of the first content,
generating a second content related to the first content based on at least a portion of the information of the first content, providing the second content to the second user,
issuing a second non-alternative token related to the second content by a predetermined period after giving the second content to the second user.
a control method comprising:

According to one of the embodiments of the present disclosure, the present disclosure is useful as a game system, a program, a control method, a server device, and a terminal device that promote the distribution of NFT content and provide a new video game with higher interest.

1. A non-transitory computer-readable recording medium having recorded thereon a video game processing program for causing a server device in a game system including a terminal device that executes a video game including one or more contents used in a video game and a server device that is connected to the terminal device via a communication network to control the video game, the game program causing the server device to perform functions comprising:
progressing the game;
associating a first user as an owner of the first content;
generating second content related to the first content based on at least a part of information of the first content;
providing the second content to the second user; and
issuing a non-fungible token (NFT) related to the second content withing a predetermined period since the second content is provided to the second user.

2. The non-transitory computer-readable recording medium according to claim 1, wherein the functions further comprise:
enabling second content to be assigned to second user different from first user when predetermined assignment enabling condition is satisfied.

3. The non-transitory computer-readable recording medium according to claim 1,
wherein the generating second content comprises visually changing the appearance of the first content.

4. The non-transitory computer-readable recording medium according to claim 1,
wherein each content of the first content and the second content comprises attribute information, and
wherein the generating second content is based on attribute information of the first content.

5. The non-transitory computer-readable recording medium according to claim 4,
wherein the attribute information comprises a numerically convertible feature quantity set in a plurality of items, and
wherein the generating second content comprises:
determining attribute information of second content to be less than the total value of feature amounts included in attribute of first content; and
generating the second content having the determined attribute information.

6. The non-transitory computer-readable recording medium according to claim 4, wherein the functions further comprise:
storing attribute information that is configured for the second content in association with attribute information of the first content,
wherein the generating second content comprises generating the second content having the attribute information.

7. The non-transitory computer-readable recording medium according to claim 1, wherein the functions further comprise issuing another NFT related to the first content before associating the first content with the first user.

8. The non-transitory computer-readable recording medium according to claim 2, wherein the functions further comprise registering the second content in a predetermined market for sale to the second user.

9. The non-transitory computer-readable recording medium according to claim 1, wherein the functions further comprise giving a benefit for advantageously progressing the game to the second user who possesses the second content corresponding to the issued NFT.

10. The non-transitory computer-readable recording medium according to claim 1, wherein
an upper limit number is assigned to at least one of the first content or the second content.

11. A game system comprising:
a terminal device configured to execute a video game including one or more contents;
a server device configured to connect to the terminal device via a communication network, the server device configured to control the video game; and
at least one processor configured to:
progress the game;
associate a first user as an owner of the first content;
generate second content related to the first content based on at least a part of information of the first content;
provide the second content to the second user; and
issue an NFT related to the second content within a predetermined period since the second content is provided to the second user.

12. A control method executed in a game system comprising at least one processor, the method comprising:
proceeding with the game;
associating the first user as an owner of the first content;
generating a second content related to the first content based on at least a portion of the information of the first content;
providing the second content to the second user; and
issuing an NFT related to the second content within a predetermined period since the second content is provided to the second user.
